(19) United States
(12) Patent Application Publication
(10) Pub. No.: US 2007/0283493 A1
(43) Pub. Date: Dec. 13, 2007

(54) Fire Blocking Removable Cover

(75) Inventors: Eberhard Link, Raleigh, NC (US); James Frasch, Hollis, NH (US); Ashutosh P. Karnik, Andover, MA (US); Anke Bold, Morrisville, NC (US); Amelia Tosti, Durham, NC (US); Charles Mason, Nashua, NH (US)

Correspondence Address: FREUDENBERG NONWOVENS L. P., 3440 INDUSTRIAL DRIVE, DURHAM, NC, 27704, US

(73) Assignee: Freudenberg Nonwovens Limited Partnership, Durham, NC (US)

(21) Appl. No.: 11/759,586

(22) Filed: Jun. 7, 2007

Related U.S. Application Data
(60) Provisional application No. 60/804,457, filed on Jun. 12, 2006.

(51) Int. Cl. B32B 23/02; B32B 27/04; D04H 1/46; A47G 9/00

(52) U.S. Cl. 5/483; 442/415; 442/402; 442/405; 442/136; 428/192; 5/954

(57) ABSTRACT

The present invention relates to a flame-retardant removable cover which may be applied to a mattress. The removable cover, when applied to mattress, may reduce the peak heat release rate and/or total energy released in accordance with 16 CFR 1633 testing protocols. The cover may comprise a non-woven material. The removable cover may also comprise a non-woven type construction and an elastomeric material. The removable cover may therefore be designed with respect to the different requirements of those mattresses to which it may be applied to assist in meeting open flame mattress flammability standards.

### CROSS-REFERENCE TO RELATED APPLICATIONS

The present application claims the benefit of the filing date of U.S. Provisional Application Ser. No. 60/804,457, filed Jun. 12, 2006, the teachings of which are incorporated herein by reference.

### FIELD OF THE INVENTION

The present invention relates to mattress pad including fire blocking materials. In particular, the mattress pad may be combined with a mattress and may help to improve fire blocking properties of the mattress.

### BACKGROUND

The U.S. Fire Administration reported in its March 2002 issue (Vol. 2, Issue 17) that an estimated 20,800 fires are attributed to mattress/bedding fires causing approximately 380 fatalities each year. To prevent these hazards and others associated with upholstered goods in the home and various institutions, flame retardant materials have been incorporated directly into mattresses and upholstery to reduce the hazards of open flame and other incendiary exposure.

There are a number of methods to directly incorporate flame retardant materials into mattresses and upholstered goods. Single or blended fibers, including flame retardant fibers, may be blended into a single layered sheet structure through processes such as air-laying, carding, needle punching or spunbonding. Other times, multiple layers of single or blended fibers may be joined together to create a sheet structure. It is then possible to directly incorporate or laminate flame retardant fabrics to the various mattress panels or to upholstered pieces; particularly in areas which are susceptible to exposure. It is also possible to directly treat the fabrics with flammable materials with flame retardant additives or treatments, instead of, or in addition to incorporating flame retardant fibers into the sheet structures.

As a consequence of the above there have been efforts to establish standards for testing open flame flammability of mattresses. California, e.g., has enacted regulations in 2001 which requires all mattresses to be sold effective January 2005 to meet the performance requirements of California Technical Bulletin 603. On Feb. 16, 2006 the U.S. Consumer Products Safety Commission approved the new national flammability standard for mattresses and futons. The new nationwide standard, known as 16 CFR 1633, is expected to go into effect on Jul. 1, 2007. This standard will set two criteria to limit the growth of fire in mattress or mattress sets. The criteria are: (1) the mattress sets must not exceed a 200 kilowatts (kW) peak heat release rate within 30 minutes of the test; and (2) the total energy released must be no more than 15 megajoules (MJ) for the first 10 minutes of the test.

Once 16 CFR 1633 takes effect, all mattress and mattress sets manufactured, imported or renovated will be subject to the published requirements. The present invention provides a separate mattress pad that may be placed on a mattress and which may therefore assist in approaching compliance with the new federal regulations.

### SUMMARY

The present invention relates to a flame-retardant removable cover for a mattress. The removable cover, when applied to mattress, may reduce the peak heat release rate and/or total energy released in accordance with 16 CFR 1633 testing protocols. The cover may comprise a non-woven material. The non-woven type construction may be present at different basis weights and/or thicknesses and may include one or a plurality of layers. The removable cover may also comprise a non-woven type construction and an elastomeric material wherein the removable cover stretches between 1-60% and recovers about 85-100%. The removable cover may therefore be designed with respect to the different requirements of those mattresses to which it may be applied to assist in meeting open flame mattress flammability standards.

### BRIEF DESCRIPTION OF THE DRAWINGS

FIG. 1 Is a plain view of one exemplary embodiment of the present disclosure.

FIG. 2 Is a sectional view of FIG. 1 taken along line 2-2 without the mattress.

FIG. 3 Is a sectional view of FIG. 1 taken along line 2-2 encasing a mattress.

### DETAILED DESCRIPTION

The present invention relates to a mattress pad incorporating or composed of fire blocking materials. In addition elastic fire blocking materials are described herein. In particular, the mattress pad may be placed on top of a mattress. Accordingly, the mattress upon which the pad is placed may therefore exhibit improved flame blocking properties. The term “mattress pad” is used interchangeably with the term “flame retardant removable cover.” The term “mattress” included foam mattresses, mattress comprised of foam and box spring, a mattress comprised of foam, inner spring and/or coils, the mattress may be encased with woven or knit ticking fabrics.

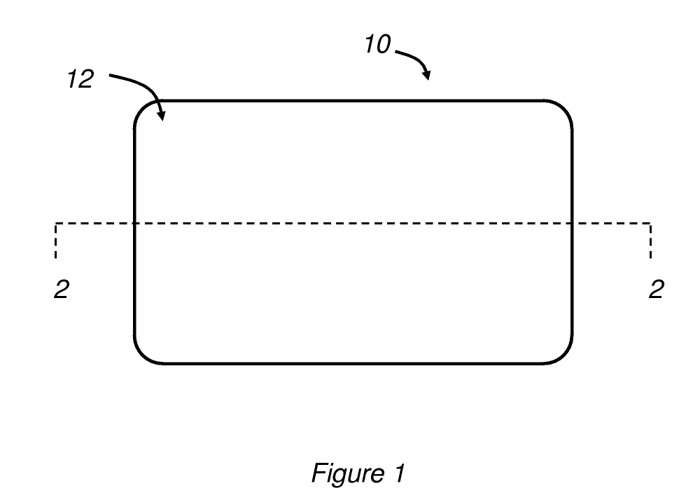

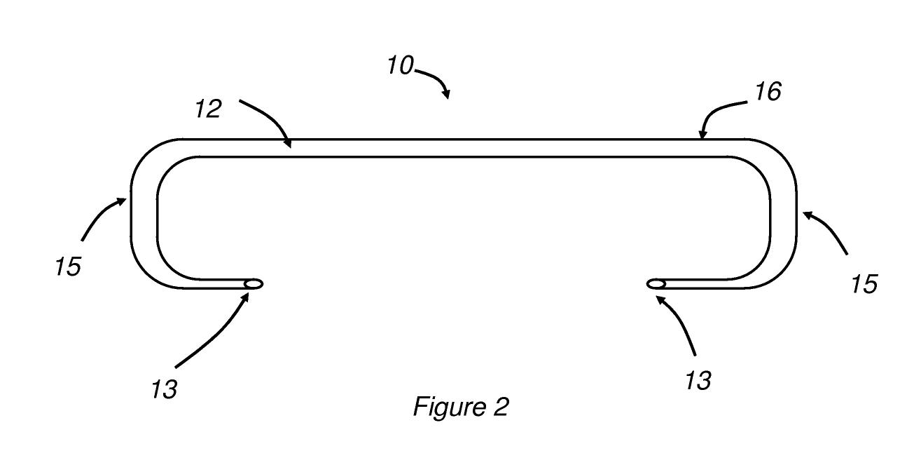

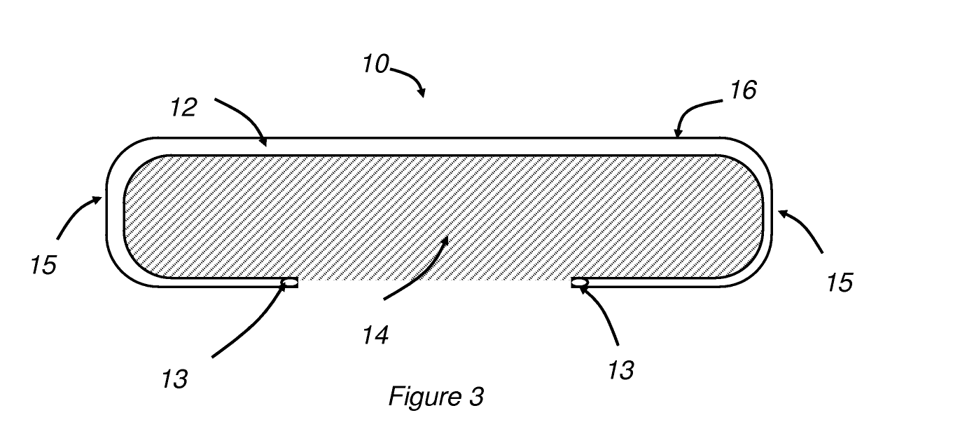

FIGS. 1-3 show an exemplary embodiment of the present invention. FIG. 1 is plain view of the flame retardant removable cover 10, comprising a fire blocking elastic fibrous assembly 12. FIG. 2 shows a sectional view along lines 2-2, of flame retardant removable cover 10, a vertical portion 15 thereof, horizontal portion 16 thereof, fire blocking elastic fibrous assembly 12, and elastic straps 13. FIG. 3 shows a sectional view along lines 2-2, of flame retardant removable cover 10, a vertical portion 15 thereof, horizontal portion 16 thereof, a fire blocking elastic fibrous assembly 12, and the flame retardant removable cover 10 partially encompassing mattress 14.

The mattress pad may assist in establishing compliance with 16 CFR 1633 and/or California Technical Bulletin 603. The mattress pad may be conveniently provided in various sizes or shapes depending upon the desired surface for which the pad may be intended. The mattress pad may also cover a single surface of the mattress or may cover various surfaces, such as, for example, the top or sleeping surface of the mattress, e.g. horizontal portion 16, FIG. 2 and one or more sides of the mattress, e.g. vertical portion 15, FIG. 2.

Depending on the construction of the mattress and end-use requirements, the mattress pad may partially cover the mattress. In particular, it has been found that partially covering the mattress fulfills technical, manufacturing and economic constraints in mattress manufacturing. In particular, a mattress need only to be covered partially to provide adequate compliance with 16 CFR 1633 and/or California Technical Bulletin 603. Further, mattress manufacturing is affected by permitting ease of installation in covering a particular mattress, i.e. one simply places the flame retardant removable cover over the mattress. Further, greater mattress manufacturing flexibility is enjoyed by allowing the mattress manufacturer to determine when during the mattress manufacturing process flame retardancy can be applied to a mattress. i.e., the cover may be applied to said mattress previous to placing outer woven or knit ticking fabric thereon. Alternatively, the cover may be applied after manufacturing is completed but prior to packing and shipping. Economic constraints are obviated by allowing a mattress manufacturer or end-user to incorporate a partial cover, thus consuming less material and lower cost to achieve compliance with 16 CFR 1633 and/or California Technical Bulletin 603. Additionally, the mattress pad may be sold directly to the consumer for use as s partial cover of a finished mattress.

The fire retardant removalable cover contemplated herein may cover between 65-% and 99-% of the total mattress surface area (M_{A}) and achieve the requirements of said flammability standards. As used herein, the coverage (C_{A}) is the percent of total mattress covered by the fire retardant removable cover and is give by the following relation:

$${C}_{A} = [ \frac{{M}_{A} - {U}_{A}}{{M}_{A}} ] \cdot 100$$

Where,
(M_{A}) is the total mattress surface area determined by the product of the mattress length (L), mattress width (W) and mattress depth (D);
(U_{A}) uncovered area is the total surface area of the mattress not encased by the fire retardant removable cover.

It should be noted that dependent on the type of fire retardant removable cover desired, the uncovered area may be a rectangle or an ellipse. Herein, the area of the rectangle is determined by the product of the length of uncovered portion of mattress (L₁) and width of the uncovered portion of the mattress (W₁). The area of the ellipse, for purposed of determining total coverage, is the product of the length of the uncovered portion of the mattress, or major axis (L₁) and the width of the uncovered portion of the mattress, or minor axis (W₁) and 0.7845.

Various means of retaining the mattress pad are contemplated. The addition of straps to secure the mattress pad directly to the mattress is one embodiment. The straps may be elastic and can be attached by known sewing techniques. The use of aramid sewing threads is contemplated herein. The elastic straps may alternatively be attached by ultrasonic sealing techniques.

The mattress pad may be manufactured as a fitted sheet. In embodiments where the “fitted sheet” construction is employed, a fire blocking elastic assembly 12 is cut to the particular shape required for the mattress. An elastomeric strap 13 under tension is then attached along the perimeter of the fire blocking elastic assembly 12 (while under minimal tension). Upon release of tension, the elastic strap, attached to elastic fire blocking fibrous assembly contracts. A mattress pad is therefore created that can be stretched to partially cover a mattress. This also ensures that the mattress pad remains flush with the mattress. The “flush” contact with mattress minimizes float and provides compliance with said flammability standard. As used herein, the term “attached” means to affix by sewing or to seal by ultrasonic means. “Along the perimeter” as used herein means the to attach, along the entire edge of a pre-cut elastic fire blocking assembly so as to join one end of the elastic strap to another end of the elastic strap. There is thus continuous attachment of the elastic strap to the elastic fire blocking assembly.

It is also contemplated herein that the mattress pad may be permanently affixed to the mattress to directly provide a mattress product. FIG. 3 shows an exemplary embodiment of the mechanism for attaching a flame retardant removable cover 10 to mattress 14.

The mattress pad may specifically assume that of a fibrous assembly. As used herein a fibrous assembly is the combination of constituent fibers or fibrous components that have been fitted together to form a structure. In particular a nonwoven structure or weft-type knitted textile structure is a fibrous assembly. The weft-type knitted textile may be described as a single jersey circular knitted textile. Further, a fibrous assembly may also be a fire-blocking material, depending on the type of constituent employed in manufacture. Thus a mattress pad may specifically take on a non-woven construction. The pad therefore may be composed of one or more fibers which may be chemically bonded, thermally bonded or mechanically interlocked. Exemplary fibers may include rayon, polyesters, bi-component polyesters, aramids, modacrylics, etc. Accordingly, either the fibers themselves may have a chemical structure that provides flame retardant characteristics or the fibers may include an additive that separately provides flame-retardant characteristics. Such additives may specifically serve to coat the fibers and provide a surface treatment and/or be dispersed within a given fiber network. Exemplary additives include polyphosphate compounds including polyphosphate emulsions, inorganic salts, aluminum oxides (e.g. Al₂O₃), boric acid compounds and/or halogen compounds.

In addition, preferably, the fiber denier of the fibers of fibrous assembly may be configured in the range of about 1-15 denier, including all increments and ranges therebetween. The fibrous assembly contemplated herein may exhibit a weight of between about 20 grams per square meter and 500 grams per square meter including all increments or values therebetween, including 50 grams per square meter, 100 grams per square meter, 350 grams per square meter etc. The fibrous assembly contemplated herein may also exhibit a density of between about 10 kilograms per cubic meter and 175 kilograms per cubic meter including all increments or values therebetween, including 30 kilograms per cubic meter, 50 kilograms per cubic meter, etc. Furthermore, the fibrous assembly may be between 0.25 mm and 30 mm in thickness including all increments and values therebetween, e.g. 2 mm, 3 mm, 5 mm, etc, plus or minus 0.01 mm.

Exemplary fibers, fibrous assemblies and nonwoven structures are also described in the following disclosures whose teachings are incorporated by reference: U.S. patent application Ser. No. 10/262,133 filed on Oct. 1, 2002; U.S. patent application Ser. No. 10/914,719 filed Aug. 9, 2004; U.S. patent application Ser. No. 11/272,436 filed on Nov. 10, 2005 claiming the benefit of U.S. Provisional Patent Application No. 60/627,049 filed Nov. 10, 2004; U.S. patent application Ser. No. 11/261,454 filed on Oct. 28, 2005 claiming the benefit of U.S. Provisional Patent Application No. 60/622,896 filed Oct. 28, 2004; U.S. patent application Ser. No. 11/263,082 filed on Oct. 31, 2005 claiming the benefit of U.S. Provisional Patent Application No. 60/623,599 filed on Oct. 29, 2004; and PCT Application No. U.S. Ser. No. 06/13434 Apr. 10, 2006 claiming the benefit of U.S. Provisional Patent Application No. 60/669,421 filed on Apr. 8, 2005.

As alluded to above, the non-woven fabrics may utilize a number of methods for maintaining the fiberous structures as well as joining more than a single fabric layer. Exemplary chemical bonding methods may include the use of adhesives, such as adhesive fibers, bi-component fibers or adhesive coatings that may be applied via powder coating, spray coating, baths, etc. Exemplary thermal bonding methods may include the use of low melting point fibers, bi-component fibers, point bonding, ultrasonic bonding, etc. Exemplary mechanical bonding may include carding, needle-punching, air-jet bonding, water-jet bonding, etc. In addition, the non-woven fabric for use as the mattress cover may be three-dimensionally deformed via thermo-mechanical processes to form three-dimensional compressible features.

Further, the mattress pad may comprise an elastic fibrous assembly. As used herein the elastic fibrous assembly is the combination of constituent fibers or fibrous components that have been fitted together to form a structure that exhibit recovery when a mechanical stress is applied to the structure and subsequently released. In particular an elastic nonwoven structure or weft-type circular knitted textile structure may be an elastic fibrous assembly. The elastic fibrous assembly may utilize a number of methods to intermingle elastic materials with fibrous assembly fire blocking materials. The elastic materials may be impregnated into, disposed or sprayed on, laminated or intermingled with fire blocking materials.

Elastic materials used herein may include for example, elastomeric polymers, such as polyurethane, chloroprene, etc. Polyurethane may include spandex fiber which may be understood to include segmented polyurethane. Spandex may be available from Dorlastan Fibers under the trade name Dorlastan or from Invista under the trade name Lycra. Polychloroprene may be understood herein to be a type of synthetic rubber. Polychloroprene may be available from E.I. DuPont de Nemours under the name neoprene. Other elastomeric type polymers may include polyisoprene, polybutadiene, polystyrene-butadiene and silicones.

Further, elastomeric nonwoven structures may be employed. In particular a meltblown nonwoven utilizing the polymers described above is employed in the present invention. In particular, a meltblown nonwoven manufactured from thermoplastic polyurethane may be employed. It is further contemplated that elastomeric spunbond nonwoven materials may be used. Fiber diameters of such meltblown structures or often less than 30 micrometers. These structures may be described as a micro-denier nonwovens as is known in the art. Further, elastomeric materials that combine the beneficial attributes of spunbond and meltblown nonwovens are contemplated for use as elastomeric components in the present invention. These materials may comprise such structures as SMS, SMMS and SMSMS materials and the like.

In addition to the elastomeric materials described above, elastic netting materials are employed in the present invention to impart the required stretch and recovery properties. For example, a thermoplastic netting material such as Rebound 5500 available from Conwed Netting Solutions Inc. may be employed.

It is contemplated that a fire blocking fabric containing one or more layers may be impregnated by a polymer dispersion of an elastomeric material. The dispersion may generally be understood herein as polymer suspended in a diluent. The diluents may include surfactants to maintain the stability of the polymer in the dispersion. The diluent may be solvent based or aqueous based and furthermore may be volatile. When the diluent evaporates, the polymer molecules may form a film. If the particles are not already above the glass transition temperature, it may then be necessary to heat the particles above the glass transition temperature to form a solid continuous polymeric phase about the fibers in the fire blocking fabric. It is further contemplated that the elastic polymeric dispersions may also be printed on the surface of a fire blocking fabric using continuous lines or patterns. The elastic polymer material may be deposited in the form of a dispersion, as discussed above, or in the form of a melt, which may solidify once deposited. It is also contemplated that the elastic polymer material may be deposited in melt form and optionally cross linked upon exposure to heat or radiation.

The elastic material may be disposed on one or both sides of the fabric or fibrous assembly, or the individual layers of the fabric where one or more layers are present. Lamination may be accomplished, for example, by heat bonding, point pointing or ultrasonic bonding of an elastic material to the fire blocking material. The elastomeric material may be a continuous fiber, which may be formed into a net or the elastic material may be in the form of a continuous sheet. The elastomeric materials therefore may be disposed on the fire blocking materials via a process such as laminating. In particular, an elastomeric net, extruded film or elastomeric meltblown, or spunbond-meltblown-spunbond may be attached adjacent to fire blocking materials. As used herein the term “attached” means affixed substantially parallel to the normal plane of the fire blocking material. Laminating herein embraces the use adhesives as means to secure the elastic material to the fire blocking material. The adhesive components may be applied to the non-woven material by a number of techniques. For example, the following are exemplary procedures for applying the adhesives to a given non-woven substrate:
1. Adhesives may be deposited in specific and defined areas on the nonwoven web through rotary screen or gravure printing techniques by the application of adhesive powder systems. Further, the adhesives may be applied by using successive rotary screens, each successive screen applying a different adhesive.
2. An adhesive web may be deposited directly onto a substrate combined with an adhesive deposited in specific and defined areas through gravure printing techniques. The elastomeric material may then be introduced directly thereon; heat and pressure serve to affix the elastomeric material onto the fibrous assembly.

The adhesive components in any of the embodiments herein may comprise a thermoplastic with a melting temperature between about 50-275° C. promote sufficient and adequate adhesion of the elastomeric material nonwoven to the fire blocking material. The adhesive components may include polyesters, co-polyesters, polyamides and co-polyamides. Such adhesive components may therefore include Griltex® D1582E and Griltex® 6E manufactured by EMS Inc. Further, adhesive components sold by Arkema under the trade name Platamid® 8020 and Platamid® H106 PA 80 may also be utilized. The adhesive components may be applied at a level of greater than about 4 g/m² to about 90 g/m².

The elastic material may be intermingled with the fire-blocking nonwoven material. As used herein, the term intermingling describe the combining of an elastic material with the fire blocking material in manner to integrate the elastic material within the structure of the fire blocking material. Furthermore the elastic material may be mechanically affixed to fire blocking material through processes such as needle-punching or knitting the elastomeric material with the fire blocking material. For example, the elastomeric material in the form of fibers, net or sheet may be needle-punched to one or more layers of a fire blocking material. The elastomeric material may also be knit into the fire blocking material by, for example, warp knitting via use of a warp-knitting machine.

The elastic fibrous assembly may include for example, between about 30 to 99% by weight of the fire blocking material including all increments and values therebetween and between about 1% to 70% of the elastic material, including all increments and values therebetween. Weight percentages of the elastic material and the fire blocking material may be varied, along with the final basis weight to provide desired flame resistance and elasticity.

The elastic fire blocking composites may be stretched up to and greater than about 1 to 60% of the initial length of the composite material and any increments and values therebetween including 25%, 26%, etc. Depending upon the amount the composite is stretched, recovery may be between about 85-100% including all increments and values therebetween. In addition, the composites herein may be repeatedly stretched to the indicated levels and repeatedly recovered within the range of about 85-100% including all values and increments between about 85-100%. Stretch and Recovery as used herein is tested according to ASTM D 3107-75 and is incorporated herein by reference in its entirety.

Expanding upon the above, it can be appreciated that the removable cover comprising an elastic fire blocking material herein, when applied to a mattress or other similar surface, that has elasticity, may be able to substantially match the elasticity and recovery characteristics of such surface and stretch and recover without substantial buckling. Accordingly the elastic fire blocking composite herein may stretch and recover in a manner that is substantially equal to the stretch and recovery of mattress material, such as foam. In addition, should the mattress include a layer of material (ticking) that is capable of stretch and recovery, the elastic fire blocking material is capable of a stretch and recovery that is substantially equal to the stretch and recover of such layer of material.

The mattress pad may therefore be of varying thicknesses, depending upon, e.g., the selection of the specific fibers or fire-retardant additives. In a first non-limiting example the mattress pad may be formed of one or more non-woven materials having a basis weight of between about 150-400 g/m² including all values and increments therein. For example, one may select a basis weight of about 300 g/m². The thickness may then be varied and may be about 0.5-mm-30-mm. In terms of construction and composition, such a mattress pad may comprise a non-woven thermally bonded network of fibers, which may comprise about 50-100% (wt) of a fire retardant rayon or cellulosic in combination with 30-50% (wt) of a polyester, including all values and ranges therein. More specifically, the mattress pad may comprise about 60% (wt) of a fire retardant rayon and about 40% (wt) of a polyester. The polyester component may specifically involve the use of a mixture of a bicomponent polyester and a single component polyester, wherein the bicomponent polyester is employed to assist in thermal bonding. For example, in the case where there is about 40% (wt) polyester, it may break-out into about 20-30% (wt) of bicomponent polyester and about 10-20% of single component polyester material. As an alternative to thermal bonding, the fibrous assembly described herein may also incorporate needle-punching technology.

In a further exemplary embodiment, the mattress pad may include a non-woven material which may specifically involve one or more layers that may again be joined by chemical, thermal or mechanical methods. Such a pad may be in the range of about 150 to 300 g/m², including all values and increments therein and a thickness of about 0.5 to 3.0 mm, including all values and increments therein. For instance, in the case of single layer type construction the pad may utilize a combination of: (a) flame-retardant rayon; (b) modacrylic; and (c) polyester. The flame retardant rayon may be present at about 60-80% (wt), the modacrylic at about 10-30% (wt) and the polyester at about 5-15% (wt). In the case of a two layer pad, the pad may include a first layer containing a mixture of aramid and flame retardant rayon and a second layer that may rely upon the use of modacrylic and polyester. The aramid may be present at about 10-20% (wt) and the flame retardant rayon may be present at about 80-90% (wt). The modacrylic may be present at about 50-70% (wt) and the polyester may be present at about 30-50% (wt).

In yet a further exemplary embodiment, the need for flame retardancy may be selectively increased at one section of the cover relative to the other section of the cover. One mechanism to accomplish the selective flame retardancy is to adjust the basis weight and/or thickness of the mattress pad as it corresponds to the side or top of the mattress to which it covers. For example, referring to FIG. 2, the basis weight of the fire blocking elastic fibrous assembly 12 along the horizontal portion 16 of flame retardant removable cover 10, may range from 150-400 g/m² including all values and increments therebetween. Preferably the basis weight may range between 275-400 g/m² along horizontal portion 16. Independently of horizontal portion 16 the basis weight of the fire blocking elastic fibrous assembly 12 along the vertical portion 15 of flame retardant removable cover 10, may range from 150-400 g/m² including all values and increments therebetween, preferably the basis weight may range between 150-275 g/m² along vertical portion 15. Thus, the vertical and horizontal portions of the mattress pad may have different basis weights relative to each other depending on the end-use requirements.

It is contemplated the differing fibers and fiber blends may be used to selectively adjust the level of fire protection desired for one section of the cover relative to another. It is further contemplated that increasing the amount for flame retardant additives incorporated onto a fibrous assembly by 5-% to 50-% to accommodate a desired selective increase in fire protection of one portion of the cover relative to the another portion of the cover.

It may therefore be appreciated that the present invention provides a flame-retardant removable cover for a mattress, wherein the flame retardant removable cover may include non-woven material. The removable cover, when applied to mattress, may reduce the peak heat release rate and/or total energy released as prescribed by 16 CFR 1633 testing protocols. For example, the cover, when applied to a mattress, and tested in accordance with 16 CFR 1633, may provide a peak heat release of less than about 200 kilowatts within 30 minutes of testing. In addition, the cover, when applied to a mattress, and tested in accordance with 16 CFR 1633, may provide a total energy release of less than about 15 megajoules within 10 minutes of testing.

The following examples are provided by way of illustration and are in no way intended to limit the scope of the inventive concept.

### EXAMPLE A

In a first non-limiting example an elastomeric web comprising a polypropylene and polystyrene-polybutadiene block copolymers deposited directly onto a needlepunch nonwoven level of 60 g/m². The needlepunch nonwoven was comprised of fire retardant rayon, Modacrylic and polyester and had a basis weight of 140 g/m². The elastic fibrous assembly thus was approximately 200 g/m². Samples were then tested according to ASTM 3107-75. The values reported for stretch, recovery and %-growth were as follows:

| Parameter | Value |
|---|---|
| %-Stretch MD/CD | 5/30 |
| %-Recovery MD/CD | 68/80 |
| %-Growth MD/CD | 1/6 |

### EXAMPLE B

In a second non-limiting example an elastomeric extruded netting material (available from Conwed Netting Inc. as Rebound 5500) is laminated directly to a needlepunch nonwoven creating an elastic fibrous assembly. The needlepunch nonwoven with a basis weight of 140 g/m² comprises a flame-retardant rayon, Modacrylic, and polyester fibers. The elastic fibrous assembly thus was approximately 300 g/m² and had a thickness of 1.8-2.8 mm. The tensile strength of the elastic fibrous assembly is 27-lbs (120-N) in the machine direction and 23-lbs (102-N) in the cross direction. Elongation at break values were 75-% and 160-%, machine direction and cross direction, respectively. Samples were then tested according to ASTM 3107-75. The values reported for stretch, recovery and %-growth were as follows:

| Parameter | Value |
|---|---|
| %-Stretch MD/CD | 3/10 |
| %-Recovery MD/CD | 82/92 |
| %-Growth MD/CD | 1/1 |

This flame retardant removable cover was tested in accordance to TB603/16CFR1633 and has passed consistently the test criteria of below 15 MJ in first 10 minutes and below 200 kW in 30 minutes with actual data of 7.83 MJ in first 10 minutes and 39.86 kW in 30 minutes

### EXAMPLE C

In yet another non-limiting example an circular knitted fabric (Style 50093 available from McMurray Fabrics) comprising a segmented polyurethane fiber and cotton was impregnated with a phosphate compound thereby creating an elastic fibours assembly. The elastic fibrous assembly thus was approximately 140-190-g/m². The thickness of the fibrous assembly was 0.25-0.5 mm. Samples were then tested according to ASTM 3107-75. The values reported for stretch, recovery and %-growth were as follows:

| Parameter | Value |
|---|---|
| %-Stretch MD/CD | 60/122 |
| %-Recovery MD/CD | 94/92 |
| %-Growth MD/CD | 3/10 |

This flame retardant removable cover was tested in an internal flame tester in accordance to TB603/CFR1633 and did not show any cracking or breaching after exposure to the large flame burner.

### EXAMPLE D

In yet another non-limiting example an elastomeric meltblown web (PUMB 100) with a basis weight of 100-g/m² formed from a thermoplastic polyurethane polymer was subsequently needled to, so as to be intermingled with, a needlepunch nonwoven. The needlepunch nonwoven comprises a flame-retardant rayon; modacrylic; and polyester fibers. The needlepunch nonwoven has a basis weight of 240-g/m². The elastic fibrous assembly thus was approximately 340-g/m². Samples were then tested according to ASTM 3107-75. The values reported for stretch, recovery and %-growth were as follows:

| Parameter | Value |
|---|---|
| %-Stretch MD/CD | 12/17 |
| %-Recovery MD/CD | 87/87 |
| %-Growth MD/CD | 1/2 |

This flame retardant removable cover was tested in an internal flame tester in accordance to TB603/CFR1633 and did not show any cracking or breaching after exposure to the large flame burner.

### EXAMPLE E

In yet another non-limiting example a fibrous assembly was formed. A needlepunch nonwoven comprises a flame-retardant rayon; modacrylic; and polyester fibers. The needlepunch nonwoven has a basis weight of 100-g/m². Samples were then tested according to ASTM 3107-75. The values reported for stretch, recovery and %-growth were as follows:

| Parameter | Value |
|---|---|
| %-Stretch MD/CD | 27/37 |
| %-Recovery MD/CD | 41/34 |
| %-Growth MD/CD | 16/24 |

Note that in each example, A,B, C and D, minimal %-growth is observed. Thus these particular samples displayed low permanent deformation when applied to a load according to ASTM 3107-75. Whereas Example E, which is a flame retardant removable cover comprised of a fibrous assembly with no elastic component fibrous, showed moderate permanent deformation.

In examples A, B, C and D the elastic fibrous assembly was then cut to form a shape suitable for a fitted-sheet type construction. An elastic strap, while under tension, was sewn directly along the perimeter of the elastic fibrous assembly. A fitted-sheet type construction was formed. Thus a flame retardant removable cover was thus formed.

The foregoing description is provided to illustrate and explain the present invention. However, the description hereinabove should not be considered to limit the scope of the invention set forth in the claims appended here to.

What is claimed is:

1. A flame-retardant removable cover for a mattress, wherein said flame retardant removable cover when applied to mattress, and tested in accordance with 16 CFR 1633, provides: (a) a peak heat release of less than about 200 kilowatts within 30 minutes; and (b) a total energy release of less than about 15 megajoules within 10 minutes.

2. The flame retardant removable cover of claim 1 comprising a non-woven material.

3. The flame retardant removable cover of claim 1, comprising a non-woven material wherein said non-woven material includes flame-retardant additives.

4. The flame retardant removable cover of claim 3 wherein said additives are selected from the group consisting of phosphate compounds, inorganic salts, aluminum oxides, boric acid compounds, halogen compounds and mixtures thereof.

5. The flame retardant removable cover of claim 1, wherein said flame retardant removable cover is affixed to said mattress.

6. A flame-retardant removable cover for a mattress, wherein said flame retardant removable cover when applied to mattress, and tested in accordance with 16 CFR 1633, provides: (a) a peak heat release of less than about 200 kilowatts within 30 minutes; and (b) a total energy release of less than about 15 megajoules within 10 minutes, comprising an elastic fibrous assembly.

7. The flame retardant removable cover of claim 6, wherein said elastic fibrous assembly stretches between 1-60% and recovers about 50-100%.

8. A flame-retardant removable cover for a mattress, wherein said flame retardant removable cover when applied to mattress, and tested in accordance with 16 CFR 1633, provides: (a) a peak heat release of less than about 200 kilowatts within 30 minutes; and (b) a total energy release of less than about 15 megajoules within 10 minutes, comprising a nonwoven material and an elastomeric material.

9. The flame retardant removable cover of claim 8 wherein said non-woven material comprises at least three fiber components.

10. The flame retardant removable cover of claim 9, wherein said first fiber component containing polyacrylonitrile copolymer with a halogen containing monomer; and a second fiber component comprising viscose fiber containing silicic acid, regenerated cellulose fiber or melamine/formaldehyde fiber.

11. The flame retardant removable cover of claim 10, wherein said nonwoven material further comprises a third fiber component comprising aramid fiber, melamine/formaldehyde fiber, polyester fiber or natural fiber.

12. The flame retardant removable cover of claim 8, wherein said non-woven is a needle-punched nonwoven.

13. The flame retardant removable cover of claim 8, wherein said nonwoven material is adjacent to said elastomeric material.

14. The flame retardant removable cover of claim 8, wherein said nonwoven material is intermingled with said elastomeric material.

15. The flame retardant removable cover of claim 8, wherein said nonwoven material and said elastomeric material stretches between 1-60% and recovers about 85-100%.

16. A flame retardant removable cover, wherein said flame retardant removable cover when applied to mattress, and tested in accordance with 16 CFR 1633, provides: (a) a peak heat release of less than about 200 kilowatts within 30 minutes; and (b) a total energy release of less than about 15 megajoules within 10 minutes, comprising:
a needle-punched nonwoven;
an elastomeric material adjacent to said needle-punched nonwoven;
an elastic strap attached along perimeter of said elastomeric material and said needle-punch nonwoven to cover all or a portion of said mattress.

17. A flame retardant removable cover, wherein said flame retardant removable cover when applied to mattress, and tested in accordance with 16 CFR 1633, provides: (a) a peak heat release of less than about 200 kilowatts within 30 minutes; and (b) a total energy release of less than about 15 megajoules within 10 minutes, comprising a knitted textile material.

18. The flame retardant removable cover of claim 17 wherein said knitted textile material comprises at least two fiber components; said first fiber component is selected from the group comprising cellulosic fibers; said second fiber component selected from the group comprising polyurethane, chloroprene, polyisoprene, polybutadiene, polystyrene-butadiene and silicones.

19. A flame-retardant removable cover for a mattress, wherein said flame retardant removable cover when applied to mattress, and tested in accordance with 16 CFR 1633 reduces the peak heat release rate and/or total energy released, comprising an elastic fibrous assembly.

20. The flame-retardant removable cover of claim 19, wherein said cover, when applied to a mattress, and tested in accordance with 16 CFR 1633, provides a peak heat release of less than about 200 kilowatts within 30 minutes.

21. The flame-retardant removable cover of claim 19, wherein said cover, when applied to a mattress, and tested in accordance with 16 CFR 1633, provides a total energy release of less than about 15 megajoules within 10 minutes.

22. A method for producing a flame-retardant removable cover wherein said flame-retardant removable cover, when applied to a mattress, and tested in accordance with 16 CFR 1633, provides: (a) a peak heat release of less than about 200 kilowatts within 30 minutes; and (b) a total energy release of less than about 15 megajoules within 10 minutes, comprising the steps of:
providing a fibrous assembly;
providing an elastomeric material;
a first affixing step affixing said elastomeric material to said fibrous assembly to form an elastic fibrous assembly;
a second affixing step affixing an elastomeric strap around the perimeter of said elastic fibrous assembly to form a flame-retardant removable cover.
